(19) United States
(12) Patent Application Publication
(10) Pub. No.: US 2011/0088081 A1
(43) Pub. Date: Apr. 14, 2011

(54) METHODS FOR EFFECTING REMOTE INTERVIEW INVITATIONS

(75) Inventors: Mikael Par Ceril FOLKESSON, Dackev (SE); Andreas Emil Folkesson, Dackev (SE); Vanessa T.S. Wu, Dackev (SE)

(73) Assignee: iViioo, Inc., Dackevagen (SE)

(21) Appl. No.: 12/577,451

(22) Filed: Oct. 12, 2009

(51) Int. Cl. G06F 15/16; H04L 9/32; G06F 21/00

(52) U.S. Cl. 726/5; 709/206

(57) ABSTRACT

The invention comprises a method allowing for easy procurement of remote interviews across different web servers. While browsing through prospective candidate personal profiles (or online resume) on e.g. a job-marketplace website, a community website or a networking website, an inviter can directly with limited user input invite any given prospective candidate for a remote interview. By the click of a link embedded within the prospective candidate's profile, the system will invoke a second web server which selects a remote interview profile including information about the open (job) position, remote interview questions and parameters related to the remote interview. The system then associates the remote interview profile, the prospective candidate and the inviter and generates a remote interview invitation link including the associated parameters and sends it to the prospective candidate by e-mail. Once the prospective candidate clicks on the link included in the invitation e-mail she is directed to the remote interview web page which can commence immediately at the second web server. The remote interview webpage display customized look and feel based on the parameters associated with the remote interview profile. Since the associated parameters are included in the link, the second web server can retrieve and use the correct parameters for the remote interview. A candidate can also consent to embed the above remote interview mechanism to allow any inviter sees her online profile to directly invite her for an interview.

A method is also described where any prospective candidate can with limited user input invite themselves to a remote interview for e.g. an open position they are interested in. While creating or editing an open position on e.g. a job-marketplace website, an inviter may invoke a second web server to select a public remote interview profile, create and place a link within the job-posting, thus allowing any prospective candidate to invite themselves for a remote interview. Once a prospective candidate clicks on the link, they will be prompted by the second web server to provide their name and e-mail address to which the system will then associate the public remote interview profile, the prospective candidate and the inviter. A remote interview invitation link including the associated parameters will then be included in an e-mail automatically sent to the prospective candidate, the link leading to the remote interview which can commence immediately at the second web server.

The system streamlines the interview screening process when open positions, candidate resumes, remote interview functionality are placed across different web systems. The system generates connecting links that lets different types of users initialize an interview request or an interview invitation from the web system they are currently using.

Using the invention, the interview process protects candidate's privacy better across different systems, and because of the unique interview identifier is assigned and used to facilitate the interview process, it allows different types of human resource management systems to become the starting point of an interview.

### FIELD OF THE INVENTION

The invention is applicable to human resources management systems in general, and candidate screening through remote interviewing in particular. While the solutions described herein are exemplified using job postings as a main example scenario, they are applicable to “jobs” in a wider sense, including any paid or unpaid tasks such as e.g. talent competitions, university admissions, skill assessment, professional certification, candidate interview coaching, skill assessment practicing, online training tests, collaborative problem solving, expert marketplace, knowledge crowd-sourcing, web conferencing, personal coaching, dating services, virtual medical consultation, remote legal services consultation, speech rehearsal etc.

### BACKGROUND OF THE INVENTION

Currently, the market model for connecting prospective job candidates to prospective job positions is typically split among several players; FIG. 1 shows the different entities and their typical interactions (100). First of all there is the employer (110) (a party wishing to fill a vacant job position) and the candidate (170) (a party wishing to find a vacant job position, a potential employee). They can connect at a Job Marketplace (JM) (130) (a place that collects candidates' CVs (resumes) and employers' job postings, and offers both employers and candidates search tools to find the ideal match). The JM provider can charge the employer and/or the candidate for the service of using the marketplace. There are also Independent Talent Databases (ITD) (140), managed by parties aiming to create high-quality or skill/industry targeted databases of candidates, which include e.g. the candidates' CVs, and offering their services to employers. There are several forms of ITDs, e.g. those created by prospective candidates themselves, and those created through explicit search for appropriate candidates through various channels, traditionally called “head-hunting firms”. There is also the Talent Screener (TS) (120), a party that explicitly tries to collect and screen a targeted selection of candidates for given job postings, or generally for given skills (skill-certification). The TS role may exist within the employer or it may be a separate party providing its services to an employer, traditionally called “recruitment process outsourcing agent (RPO)”. Usually a professional working as a TS or operates the TS function holds a position of recruiter, inviter, talent scout, talent sourcer or staffing coordinator. Some employers at least partly take on the role of the ITD and/or the TS themselves, in the sense that they can build their own candidate database, e.g. asking candidates to submit resumes and job applications on their own Career Website (132) (CW), and/or they can perform their own candidate screening. An employer may also use an Application Tracking System (ATS) to record and follow all the screening, interviewing, and hiring activities for each job position opening and keep track of history and results of each candidate's job applications. Finally, there is also the Candidate Support (CS) provider (150), which provides services to the candidate, such as interview skill coaching or CV editing/writing assistance. A relatively new player is the Video Interview Management (vRIM, video-based Remote Interview Management system, a type of RIM) provider (160), which will be described further below.

The typical recruitment process (200) is depicted in FIG. 2. When an employer has an opening (201) and determines to outsource the recruitment (202), the employer can passively post jobs on the JM or their own CS (210), assign a TS (e.g. inviter) to screen candidates and/or approach an ITD to find candidates (220) proactively. Once the candidate submitted their updated resume or application (221), the prospective candidates are then screened by a TS based on CVs and references (203), and one or more promising candidates would be interviewed (204), evaluated and finally selected for the open position (205). One or more interviews will be conducted and evaluated (204) by either TS or other interviewers, e.g. 1) the hiring manager who owns the job opening, or 2) other current employees who may influence the selection decision because of their current job responsibility and/or their expertise is related to this job opening, or 3) experts who are asked to join the evaluation process to provide some objective 3^{rd} party opinions.

Traditionally, due to the TS having limited amount of time and budget to coordinate the interview schedule between the prospective candidates and an employer's other interviewers (hiring team members), the TS usually selects less than 7 candidates for initial interviews and passes on 2-3 candidates after the preliminary screening. Traditionally, a TS would use phone interviewing or an electronic message questionnaire to conduct the initial assessment and screening. Today however, more TS inviters have started to interview candidates remotely, i.e. not requiring the candidate to be co-located with the TS inviter or the hiring team members. For this, video-based interview solutions are used to invite many times more candidates to participate in video interviews. Using such tools, a candidate receives a video interview invitation, accesses a RIM system to start the interview, sees the interview questions displayed on screen one at a time, and answers them unrehearsed within a pre-set time limit while a web cam records and stores the video interview responses of this candidate. By combining candidates' CV and video interview responses, it not only brings a clearer picture of the candidate's experience, communication skills, and expertise, but also allows interviewers to review candidates remotely using a web browser anytime they want.

The type of video interview described above is what is commonly known in the field as “asynchronous” or “on-demand” interviewing, since there is no real-time interaction between the parties of the interview. The questions are provided to the candidate in the form of pre-written text, or pre-recorded audio/video. However, some TS inviters have started to use live video tools (liveRIM, live Remote Interview Management system) as an enhancement to phone interviews, allowing interviewers to interact with the candidate via real-time video streaming, bringing some advantages in terms of assessment possibilities. Since the participants of the live video interview need to be present at the same time, live video interview is however somewhat less scalable and usually takes the same effort as coordinating phone interviews. In particular, the element of scheduling is introduced, as compared to asynchronous interviews.

Other existing video-based tools within human resources systems include the possibility for a candidate to upload a self-introduction along with her CV (Curriculum Vitae) to the JM's, ITD's or employer's website.

Although existing remote interview solutions provide clear and significant benefits to the recruiting process, saving time and cost, there are still some drawbacks.

In existing systems, getting a candidate to perform a remote interview is a relatively cumbersome and time-consuming task. One important reason is that relevant pieces of information needed to invite/inform participant of a remote interview are scattered across different systems and databases. Information such as candidates' email address, interviewers' email address, interview questions, job opening information, are stored in different systems, some are internal and some are external to the employer. Multiple web-sites are involved, operated by different entities and implemented using diverse technologies on different web-servers. The main database which includes the candidate profiles and job postings is typically the JM, CW, (or ITD) website, while the Remote Interview Management (RIM) system function and storage RIM is typically provided by a Remote Interview Service Provider (RISP) at a separate website. The candidates' application history, TS and interviewer's credentials, and interview assessments may be stored in the employer's ATS. Moreover, some employers may have a separate interview question database.

In current systems, when an employer or TS sees a candidate's resume on a JM, ITD website, or ATS and wishes to invite that candidate to a remote interview, there is no simple way of accomplishing that. She would first obtain the contact details of the candidate from the JM or ITD website or from the ATS, and then go to the RIM website to manually create a remote interview profile, which includes interview questions and job opening basic information, and then send an invitation electronic message entering the contact details obtained for the candidate, and in the electronic message referring to the RIM website where the remote interview will take place. Once the remote interview responses are stored, the TS may also need to report the result to the employer's ATS manually, e.g. copying the feedback and scores collected from interviewers from the RIM, and pasting them back to the ATS. The overall tasks needed makes the procedure relatively complicated and time consuming for the employer or TS because there are multiple systems and websites the TS needs to generate and retrieve critical information from and to before the remote interview process can be completed.

One way to simplify the procurement of remote interviews would be to fully integrate the functionality of the RIM website into the JM/ITD website. However, such integration is relatively complex, and may not necessarily fit the respective business models of the JM, ITD and/or RISP organizations.

Furthermore, a candidate may wish to make it public that she wishes to receive invitations for remote interviews, e.g. because she may have had training in such, or may generally believe that she would come across well in a remote interview. However, in existing systems, there is no easy way for a candidate to publish in her profile that she particularly wishes to accept requests for invitations for remote interviews, and for prospective employers to invite such candidates to a remote interview, e.g. a public video job interview request that is open to anyone who wishes to apply (talent contest).

Finally, existing solutions provide no easy way for any candidate to do a remote interview for a given job posting without having received an explicit invitation to do so. An interested candidate will typically have to send in an application for the job at the website and then wait to get a response. However, there may exist positions or situations where it is desired that more or less any prospective candidate should be able to perform a remote interview without necessarily having been invited to do so. If that would be possible, employers could find more qualified candidates from the remote interviews submitted voluntarily. While in existing solutions, a given promising candidate may never be invited due to selection mistakes or a TS′ lack of time for detailed screening. Such kind of “silent loss of talent” could be effectively eliminated if candidates have a direct way to submit their remote interviews. In particular, a text-based CV can tell very little about the candidate's communication skills and expertise, yet TSs typically spend their time on reviewing text-based CVs and need to select relatively few candidates for interviews. In other words, there is a need to generate more prospect candidates without the manual involvement of TSs to pre-select or pre-screen candidates, while allowing TSs to have skill-based screening questions via remote interviews, which would eventually result in a better quality of hire. Such a method would be most effective in helping to eliminate unqualified candidates once and for all, because after reviewing in particular video answers or remote assessment answers from the candidates, more factual evidence is presented for the decision making. Note that the more specific remote interview questions that are asked, the better the TS can evaluate the skill level differences among different candidates.

### SUMMARY OF THE INVENTION

The present invention relates generally to the field of human resources management systems and more specifically to a system and methods for procuring remote interviews where interviewer and interviewee are not co-located that addresses challenges such as those described above. (Specifically, one of the major challenges is that many pieces of information needed for setting up a remote interview are stored in multiple systems and not integrated.) According to some aspects, the present invention is directed to systems, processes, apparatus and software for increasing the efficiency of a recruiting process, such as e.g. employment recruiting or educational institution student admission application. More particularly, the invention relates to improvements in the system of inviting prospective candidates to perform remote interviews, resulting from improved techniques for creating interview profiles, the provision of invitations through single-click procedures and the interconnection of separate web-servers with minimal effort. Accordingly, the general objects of the invention are to provide novel systems, methods, apparatus and software of such character.

According to one aspect of the current invention, an “Invite NN for an interview” “button” is provided directly in or in relation to a specific candidate's profile as viewed on a web-page (or a web-link-enabled document where the button can be clicked and directed to a web-page.) When logged into e.g. the JM or ITD website, the employer or TS can through a single click of a button invite any interesting candidate in the database to participate in a remote interview, without having to explicitly consider the candidate's contact details or having to log onto any other system or contact any other party whatsoever. When the button is clicked, the employer or TS is seamlessly initiating a remote interview invitation to this specific candidate on the RISP website without the manual steps described previously to recreate e.g. the candidate's email address and contact information. The employer or TS can simply select a job position and associated interview questions they want to use that is already on RISP's system, and an invitation electronic message is automatically sent out to the candidate, including a link to a website where the remote interview will take place. Note that the employer or TS will not need to type in the RISP's website address or to log in on the RISP website to complete the invitation, because in this invention, the RISP's services can be seamlessly embedded into the JM or ITD's sites by using HTML iframe, popup windows, or other embedded frameworks. The inviting party who clicks the button only needs to select the relevant job opening and interview questions for the situation at hand. For an employer, this could include questions relevant to a given vacant position (e.g. “Please explain what are the 4Ps in Marketing.”), while for a TS it could include general questions for certification, e.g. for language skills assessment (e.g. “Please use German Language to introduce your latest achievement at work.”).

If the job opening information or interview questions have not been generated and saved at the stage of the button-click, the inviting party will be prompted by the system to complete such interview questions before the invitation is sent to the candidate. Typically, entering interview questions needs to be done only once for a given position, unless the inviting party wishes to use candidate-specific interview questions. Thus the inviting party typically has access to a database of interview questions that can be selected from e.g. pull-down menus. The electronic message sent to the candidate will include a link to the website, which is typically the RISP website, where the remote interview will be conducted. The invitation electronic message may optionally include message text and layout customization (including e.g. company logotypes) so that the candidate recognizes the inviting party, e.g. the employer or JM, so that she may feel more confident in performing and recording the interview. Once the interview has been recorded by the candidate, it may be accessed by the inviting party through secure log-on from any Internet browser in the world as is known from existing systems. The remote interview page, typically at the RISP website, can also be customized by the employer, ITD, TS, or JM, to provide the candidate with better familiarity of the employer or the position including e.g. company logotypes, or TS company name. Although the remote interview is often conducted and stored on the RISP's site, the candidate can still recognize the job opening or the employer's brand when conducting the remote interview, and would thus feel as if they are conducting remote interview on the employer or JM site.

With such an integrated interview invitation principle, the remote interview invitation process becomes very simple for the party who wishes to procure interviews, e.g. the employer or the TS. Although the RISP's technology and server may still be instrumental to being able to perform and record the remote interview, there is no full integration of the different web-servers in this solution. The involvement of the RISP becomes less visible for other parties, thus making it possible to provide invitations for remote interviews more swiftly, allowing for time-saving or the possibility to invite more candidates for interviews, thus making the recruitment process more efficient and/or comprehensive.

According to a variation of this first aspect of the current invention, an “Invite me for an interview” button is provided directly in or in relation to a candidate's profile as viewed on a web-page. The difference as compared to the “Invite NN for an interview” button described above is that it would be procured by or at least consented by the candidate herself, thus demonstrating her readiness to receive an invitation for a remote interview though the receipt of an electronic message sent to an email address the candidate specifies as the receiving email address for any remote interview requests. The candidate can easily set up her consent to accept any interview, and place the “Invite me for an interview” button on any web pages, including social networking pages or personal resume pages. Any time an employer, or TS, is interested in this candidate and would like her to take a remote interview, they only need to click on this button without going to a JM or RISP to invite this candidate. Candidates' readiness may be the result of e.g. attending coaching sessions in doing remote interviews. The technical function after the click of the button is however the same as described above.

According to a second aspect of the current invention, a “Submit an interview for this job posting” button may be provided directly within any explicit job posting which may reside e.g. at the JM's website or the employer's own career website. When browsing thorough job postings, any candidate interested in a given job posting may by a single click be directed to a video-interview page, typically the RISP website, and can start recording a remote interview for that position. Some authentication procedures may however be needed before the actual remote interview can take place, e.g. candidate needs to confirm that the email address he/she uses to apply the position is valid and he/she has legitimate access to the email address. This second aspect of the current invention can solve the problem with the situation when e.g. an employer wishes any interested candidates to submit interviews on their own accord with a minimum of effort from the employer or the TS. The effect of applying this method is a direct reduction of time and cost spending on having the TS contact candidates to do remote interviews, in particular when asynchronous interviewing is used, alleviating the need for massive scheduling efforts and manual invitation efforts.

It should be noted that the term “button” in the descriptions above is only one implementation of the provision of a web-link, or Uniform Source Locator (URL) on a web-page or any types of interactive media. Some examples include a clickable button displayed on a video, a URL link embedded in a FLASH media on a web page, or a clickable menu item on a mobile application, or a hyperlinked graphic in a digital document (e.g. PDF, Word File). Also, the texts on or in relation to these buttons are only exemplary and provided to convey the main purpose of clicking the “button”.

Although video is an important media component for a remote interview, the term “remote interview” as used herein is not necessarily limited to the use of video as the only means of communication. Audio is a fundamental component, and remote interviews could in principle use only audio. Other tools can be “whiteboarding” where typed or hand-drawing concepts or presentations can be incorporated into the communication flow. For these reasons, the term “remote interview” is used herein to encompass all fauns of interviews where interviewer and interviewee are not co-located and where they communicate using multi-media including one or more of the above-mentioned media. Furthermore, the device that candidates can use for conducting remote interviews is not limited to a personal computer (PC), it can also be a tablet PC, a netbook, a mobile phone, a kiosk, or another type of communications-capable device.

One objective of the invention is to provide systems and methods to allow for a more efficient procurement of remote interviews across different web-sites with embedded functionality avoiding complete integration of websites. Another objective of the invention is to allow for more efficient procurement of remote interviews in systems where the candidate and/or job posting database web server and the remote interview web server are separate. The invention allows for easy exchange of parameters between the first web server, e.g. a JM site, and a second web server, a RISP's site, and performs the following; authenticates the user's account, initiates the creation of a new interview profile or displays existing interview profiles and interview questions, generates an invitation identifier that maps the inviter, the candidate, and the interview profile, and sends an invitation electronic message accordingly.

Another objective of the invention is to allow inviters or talent screeners to invite a potential candidate for a remote interview by a single click operation. Inviters can click a button embedded within a candidate's name, resume, or profile in a database to send a complete remote interview invitation to the candidate they choose without having to type in any data such as credentials or any previously set remote interview questions. The electronic message will be delivered to the same email address the candidate is using in the database.

Another objective of the invention is to allow a potential candidate to publicly request to be invited for a remote interview by inviters or talent screeners by a single click operation. In one example, the system generates a link on behalf of the candidate, to indicate that the candidate is open to accept remote interview request. Wherever the button is embedded or placed on any webpage, document, or electronic message, inviters can see that the candidate is willing to accept an interview invitation. Inviters can through a “I click” operation decide interview questions, and send an invitation electronic message to the candidate, without having to bother about credentials of the candidate and without needing to visit the RISP website separately to create the invitation. The electronic message will be automatically delivered to an email address specified by the candidate.

Another objective of the invention is to allow potential candidates to invite themselves for a remote interview by a single click operation. In one example, the system generates a link that is placed within a job posting, to indicate that any candidate can submit their email address and receive an invitation to conduct a remote interview for this job opening. Any candidate can click the “single-click button” on public invitation, verify their identity, and start conducting a remote interview without contacting any inviter, nor do candidates need to get an invitation prior to clicking the button.

The invention achieves the above effect to simplify and streamline the remote interview invitation process by using appropriate identifiers to receive, store, and associate key information pieces that were previously used in different web systems.

### BRIEF DESCRIPTION OF THE DRAWINGS

These and other aspects of the invention will become apparent to those ordinary skilled in the art upon review of the following description of specific embodiments of the invention in conjunction with the accompanying figures, wherein:

FIG. 1 is a diagram showing the different entities in the recruitment field in the prior art

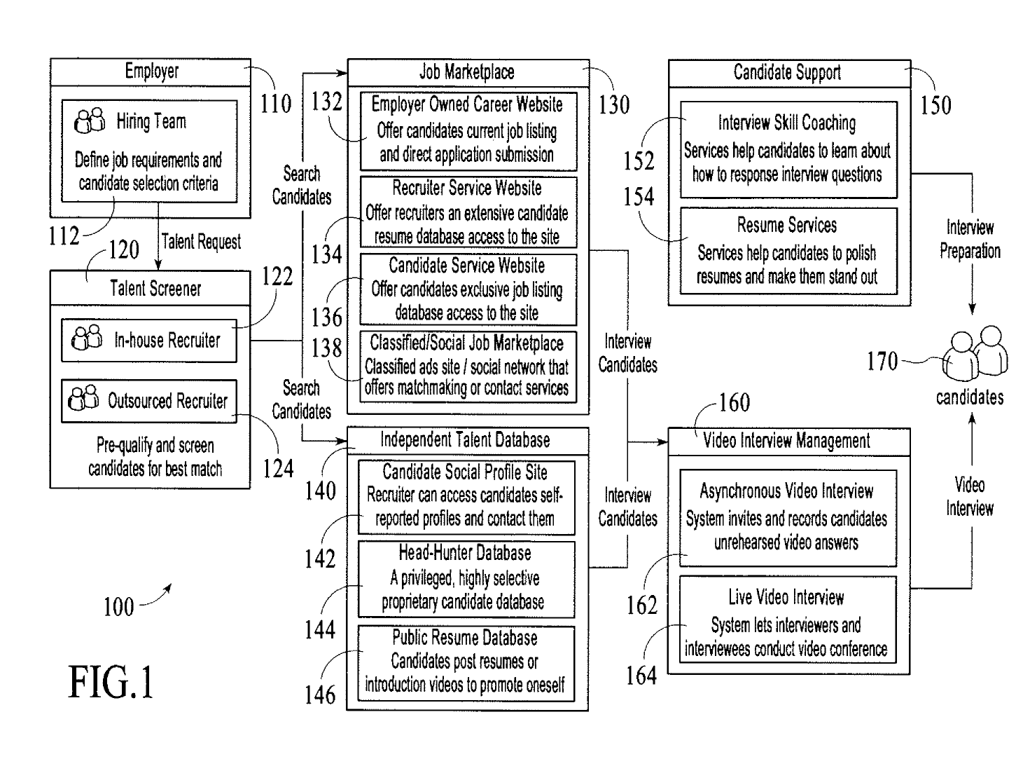

FIG. 2 is a flow diagram showing the recruitment process in the prior art

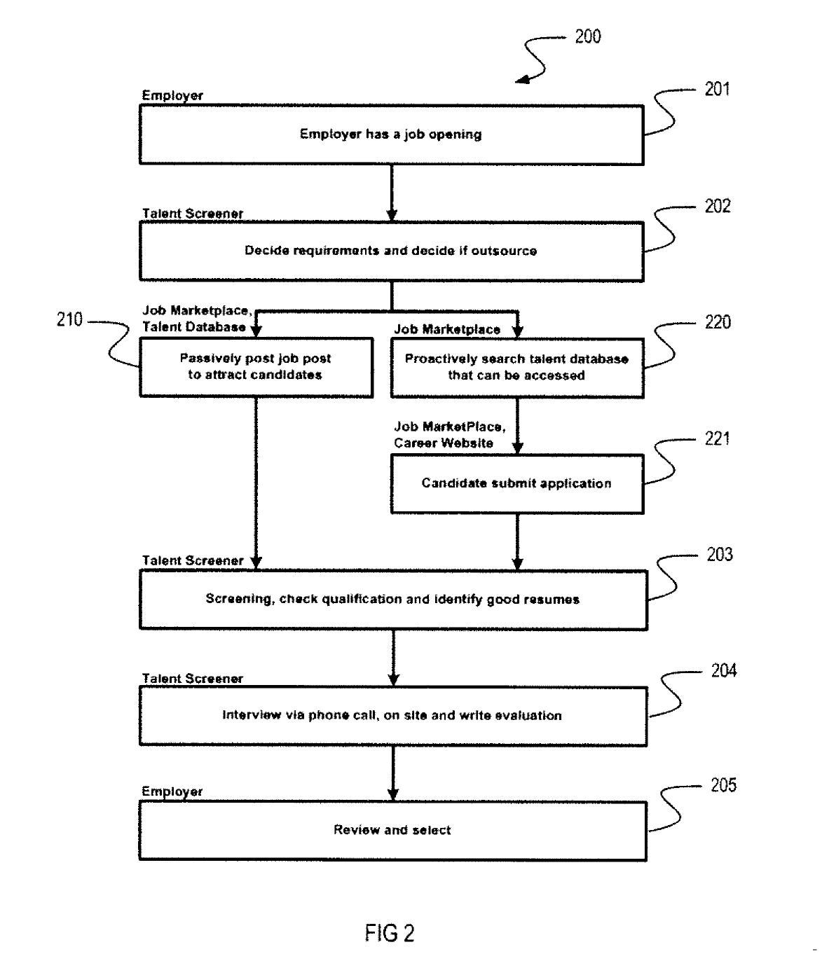

FIG. 3 is a block diagram showing the various parts of the system

FIG. 4 is a flow diagram showing the workings of the first embodiment of the present invention

FIG. 5 is a flow diagram showing the workings of the second embodiment of the present invention

### DETAILED DESCRIPTION OF THE PREFERRED EMBODIMENTS

The workings of the detailed embodiments will be described in terms of Internet-connected web-servers where web-pages are accessed by an end-user operating an Internet browser on any device that is Internet-connected through a wire-line or wireless connection. However, the communication network does not have to be the Internet, but could be any network.

For simplicity, in the following description the term “inviter” will be used for the person or entity that is interested in finding a candidate for some form of open position.

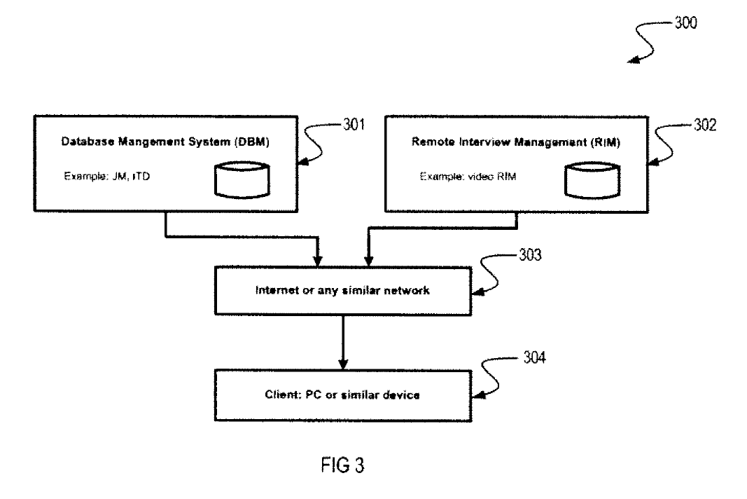

The system setup of the present invention is shown in FIG. 3 (300), where there are two separate web servers, one that includes the database of candidates profiles and job postings, corresponding to the JM or ITD web server described above, hereinafter simply denoted Data Base Management (DBM) system (301), and another that manages the interview profiles and performs the remote interviews, recordings and reviews, corresponding to the RISP web server described above, and hereinafter simply denoted Remote Interview Management (RIM) system (302). There is also the client, which is a web-browser is running on any PC or communications-capable device (304) connected to the Internet or any similar network (303).

### First Embodiment

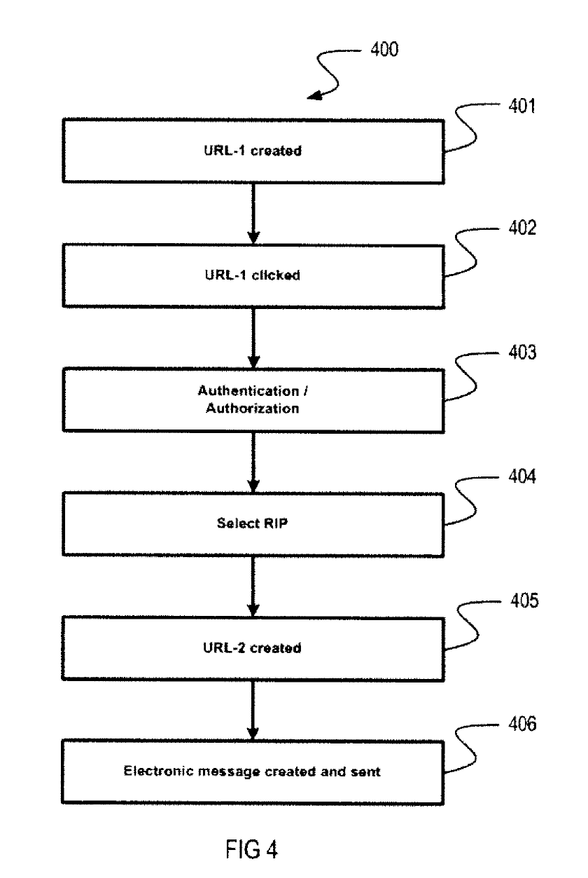

The workings of a first embodiment (400) of the present invention will now be described by means of a use case and referring to the flow chart of FIG. 4.

A link (URL) for inviting a given candidate to a remote interview is first created and included in the candidate's profile (401). When a prospective candidate is logged into the DBM system and wishes to create a new or edit an existing online personal profile (online resume) for herself, she may click on a button or be prompted by the DBM system whether she wishes to embed an “Invite me for a remote interview” link in her personal profile. (Note that several possible text strings for the link could be envisioned, including e.g. “Would you like to invite this candidate for a remote interview?” or “Click this link to interview me.”).

Alternatively, rather than prompting a candidate to include such a link in her personal profile, the DBM system could create such an invitation link automatically i.e. the DBM would automatically generate such links for candidates that exist in the system. For example, a JM usually provides candidate search function for TS, TS can search keywords and get a list including candidates' name, contact information and resume. Now the JM can use the present invention to create invitation link for all candidates and display the “invite NN for interview” button and candidate will not need to embed the button themselves. The DBM system will thus, either automatically or based on user input, create a first URL—here denoted URL-1—and embed it into a candidate's personal profile. URL-1 is directed to the RIM system and contains the following query string parameters
A code identifying the DBM system provider
Credentials of the candidate, at least the email address
Credentials of an inviter, e.g. name and/or email address
An action indicator conveying to the RIM system what kind of action it should perform

Assuming that the RIM system has the address www.rimsystem.com, URL-1 could thus for example look like:
http://www.rimsystem.com/DBMID=b80d2160-4287-11de-8a39800200c9a66&InviterID=?&CandidateFirstName=Lisa&CandidateLastName=Smith&CandidateEmail=lisa.smith@emailservice2.com&Action=invite

The DBMID is a predetermined code that the DBM system provider has received from the RIM system provider and is thus known a-priori by the RIM system, while the credentials of the candidate already exist within the DBM system database. The credentials of an inviter, the query string parameter “InviterID” is populated with a “?” above until an inviter logs into the DBM system when it will automatically be completed with e.g. the email address or a user ID of such inviter.

The “Action” query string parameter, or indicator, instructs the receiving web-server (in this case the RIM system as will be described further below) what kind of action to perform. “invite” will tell the receiving web-server to start a process of associating a remote interview profile a specific candidate, and inviting this candidate for a remote interview.

Note that this kind of URL may be placed not only in the candidate's personal profile in a JM provider's DBM system, but also in a candidate's profile in any so-called community website, such as Facebook, LinkedIn, Plaxo, Twitter or similar websites that are popular in present times. This can be relevant because inviters may also have accounts at such community websites and may use them for looking for prospective candidates for open positions.

In the following it is assumed that an inviter would also have an account at the DBM system in question and has logged in to such system providing her secure login credentials. Having logged in to the DBM system, the inviter can browse candidates' profiles through e.g. various search criteria, including e.g. those candidates that have explicitly shown an interest in a given job posting (e.g. if the DBM system in question is a JM website). When viewing the profile of a candidate, the aforementioned embedded button—which technically corresponds to URL-1—will be visible to the inviter within or in association with a candidate's profile. If the inviter clicks on URL-1 (402), a process of inviting the candidate for a remote interview begins.

Note that since the inviter is now logged in, the DBM system can automatically place e.g. the inviter's email address in the “InviterID” query string parameter field of URL-1:
http://www.rimsystem.com/DBMID=b80d2160-4287-11de-8a39800200c9a66&InviterID=alan.jones@emailservice1.com&CandidateFirstName=Lisa&CandidateLastName=Smith&CandidateEmail=lisa.smith@emailservice2.com&Action=invite

Once URL-1 is clicked (402), by use of the http protocol, the inviter's web-browser is directed to the RIM website. However it may not necessarily be visually noticeable as another website, through the use of HTML iframe, popup windows, or other embedded framework technologies known in the art. Furthermore, by detection at the RIM website of the query string parameter DBMID or the inviter's credentials, the appearance of the relevant pages at the RIM website could then be customized in such a way, e.g. by use of company logos etc, that it appears like e.g. the DBM website or the inviter's website. The RIM web server receives the query string parameters and takes action according to the “Action” parameter; in this case it proceeds to create an invitation for a remote interview.

Since this process involves the access to another web server—the RIM web server—there is a need for some form of authentication and authorization of the DBM system, and/or the inviter (403). The DBMID would first be checked against preregistered DBMIDs stored in the RIM system. Even if the DBMID is found, access may still for example be based on appropriate payments having been performed by the DBM system provider to the RIM system provider for the use of the service. Besides the DBMID being authenticated and authorized, there may also be a need to verify that the inviter has the right to access the RIM system. The inviter will be asked to provide a secure password, and to check if it matches a stored password for the provided InviterID parameter. If the provided InviterID is not found, this would be the first time the inviter clicks on such a link to invite a candidate, and the RIM server will prompt the inviter to provide her email address and a secure password, which will be stored in the RIM system. The inviter's login credentials may be stored at the RIM system, so that subsequent logins can be automated.

It should be noted that various techniques to provide different levels of security may be provided in the aforementioned authentication and authorization procedures. In the example, the inviter's email address was used as an identifier, although one could also use any type of username, the user's full name, or a combination of any of these. It is preferable however that the credentials used exist in the DBM system, since they can be automatically displayed to the user, thereby avoiding the need for the user to come up with a new user ID. As a further alternative implementation, the authentication of the DBM system provider and/or inviter may be hidden for the user by means of single sign on (SSO) solutions known in the art and generally utilizing the authentication of the inviter that has already been performed when the inviter logged onto the DBM system. It is assumed that the procedures (403) are passed successfully. In case they are not, some form of error handling system will be invoked but is not described further here as it is not a material part of the invented system and is well-known in the art.

The example URL-1 shown above includes query string parameters that are suitable for effecting the invention. However, other query string parameters can be used in addition to enhance certain aspects. For example, a parameter “LanguageID” could be used e.g. in case the DBM system supports multiple languages. If the language of the DBM system can be selected by the user, in this case the inviter, then the DBM system can also automatically set the “LanguageID” query string parameter in URL-1 to that selected language. By detection of such a parameter, the RIM system would then be able to use that language in its interface with the inviter in the steps following the clicking of URL-1.

Next, the RIM system will prompt the inviter to select parameters relating to the remote interview she wants to conduct with the candidate—here denoted Remote Interview Parameters (RIP) (404). The RIP consists of parameters that are needed to perform the remote interview, such as interview questions, candidate response time per question, and other information.

For an asynchronous remote interview, such RIP would typically include:
information about the open position (such as e.g. the title of the position, the employer and contact details)
a set of remote interview questions
parameters relating to the remote interview (e.g. the latest date to perform the interview, time allowed to think before answering interview questions, time allowed for answering interview questions, scores that can be achieved for interview questions, language of the interview, question display sequence or algorithm, question randomize method and a pre-interview questionnaire)

Typically RIP are specific to a certain open position although different RIP could in principle be created for different candidates for the same open position. Since an inviter may want to use largely the same RIP for invitations to different candidates, parts or complete selected or created RIP can be stored in the RIM system and presented as options to the inviter when selecting RIP. In particular, sets of questions may be advantageously re-used, since for a given open position posting, the desired interview questions may often be the same. The RIM system may include a large set of interview questions, which may also be increasing with time as inviters generate new questions.

The complete RIP finally selected for a certain remote interview invitation are stored by the RIM system, and an identification code is associated with it. In order for the inviter to easily re-use parts or complete saved RIP, various well-known presentation graphical user interface techniques can be used including pull-down menus, nested selection boxes or tree-structured cascade lists.

When the RIP have been selected, the system will create a second URL (405), URL-2, to be included in an electronic message which when clicked by the recipient of the electronic message will lead to the RIM website where the remote interview will be conducted. URL-2 will advantageously include a unique or quasi-unique Interview Instance Identifier (IIID), which is generated based on
A code identifying the selected RIP
The code identifying the DBM system provider
Credentials of the inviter, e.g. email address, name, or username
Credentials of the candidate, at least the email address

The IIID thus identifies the parameters it is based on, i.e. given an IIID, all of the above parameters can be reproduced from it. There are several ways of accomplishing such a mapping. For example, assuming that the IIID is a string of N characters, one could divide the N characters into 4 character strings, each N/4 characters long and identifying one of the parameters, using e.g. look-up tables.

Assuming that the RIM system has the address www.rimsystem.com, the URL-2 could look for example like:
http://www.rimsystem.com/IIID=xcnij56209-459877650388n887trg-54-gt7-r458767&Action=interview

When the recipient of the abovementioned electronic message subsequently clicks on URL-2, the Action parameter “interview” will tell the RIM system that an interview should be performed and the IIID parameter allows the RIM system to retrieve the parameters the IIID is based on, including the selected RIP for this remote interview, and thus to start the remote interview using the correct parameters.

Note that an IIID does not necessarily have to be created by the RIM system per se, but instead the parameter components upon which it is based could as an optional implementation be included as separate query string parameters in URL-2. For integrity and simplicity reasons however, it can be advantageous to create and use an IIID.

An electronic message will then be created and sent to the candidate by the RIM system (406). Parameters needed to create the electronic message are:
the candidate's credentials, including email address
the inviter's credentials
   These parameters have already been received by the RIM system through the query string parameters in the URL-1 in step (402).

Furthermore, parameters relating to the open position, needed for creating text in the electronic message are retrieved by the RIM system from the selected RIP.

As an implementation variation, one or more standard electronic message may be displayed for the inviter to select among. An automatically created invitation electronic message may look for example like:
To: <candidate's email address>
Dear <Lisa Smith>.
You are hereby invited to a remote interview for the position of <open position> at <employer>. You may do the interview at any time that suits you, but we kindly ask you to complete it before <completion date>.
To perform the remote interview, please click on the following link:
<URL-2>
Yours Sincerely,
<inviter>

In the example above, “< >” illustrates information that can be inserted automatically by the RIM system based on data it has already obtained.

Once a “send” button or similar is clicked by the inviter, the system will send the created invitation electronic message to the candidate's email address thus inviting the candidate to perform a remote interview by clicking on the aforementioned URL-2 embedded in the electronic message.

Variations in implementation of the electronic message include the possibility for the inviter to modify the text before it is sent, the automatic sending of the electronic message without the inviter having to press a send button, and the optional sending of the electronic message also to the inviter's email address as CC (courtesy copy). To enhance the efficiency, there can be an implementation where inviter selects multiple candidates at once, and then DBM creates individual URL-2 for each of the selected candidates and send out all the invitations. In this case each candidate will get a unique URL-2 generated by the present invention and will be interviewed by the same RIP.

While the present invention is mainly directed to facilitating a smooth invitation process, and not the detailed operation of the remote interview itself, a brief description of what happens after the electronic message has been sent will be given below.

Once the candidate receives the electronic message and clicks on the URL-2, she will be directed to the RIM system. The action parameter “interview” will tell the RIM system to commence a remote interview operation, and the IIID parameter will allow the RIM system to retrieve the correct RIP and other parameters related to this remote interview, and will guide the candidate through the process of recording the remote interview.

With the use of consumer web cams, microphones, and recording media functionality available in standard web-browsers or plug-ins such as FLASH Player, there is in principle no need for the candidate to download or procure any interview-specific software or hardware in order to perform the remote interview. However, depending on requirements on quality of service and/or the need for using several types of media simultaneously, it may in some cases be advantageous to require the candidate to install specific software prior to starting the remote interview. In such a case, the action parameter “interview” will trigger the RIM system to first make sure that the candidate has the relevant software installed on her device, before the actual remote interview will commence.

The relevant processing for the interview itself typically takes place in the RIM system, and interacts with the candidate through the candidate's device including web-browser, web cam, loudspeaker and microphone. The RIM system will handle the playing or the interview questions and recording of the video and audio via streaming and the recording is stored e.g. on an online database managed by the RIM system. It is also possible to have a downloadable software application on the candidate's device that can perform the remote interview on the candidate's device, encrypt the file securely and automatically upload the results to the RIM system. This latter implementation may be advantageous when there is a lack of a reliable Internet connection, so the candidate can perform the remote interview at one time and then later when the Internet connection allows, the result can be uploaded to the RIM system.

Once the remote interview is completed, recorded and stored at the RIM system, the RIM system can notify the inviter by electronic message about the existence of a new remote interview recording, since the contact details of the inviter were also part of the IIID.

### Second Embodiment

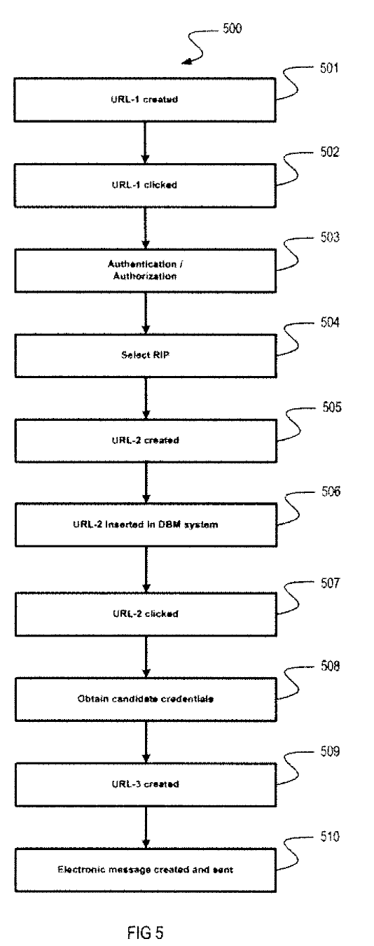

The workings of a second embodiment of the present invention will now be described in relation to FIG. 5. A candidate may be interested to browse a JM in search for potentially interesting job postings. When an interesting open position is identified, she may be interested to conduct a remote interview for it. Although in general it might not be desirable that anyone simply “invites themselves” to submit a remote interview for any open position, there may be certain positions where such a broad “self-invitation” could be acceptable. For such open positions, an “Interview for this position directly” button is created by the DBM system or posted by inviter and embedded in or in connection to an open position.

Turning to FIG. 5, when the inviter is logged into the DBM system and wishes to create a new or edit an existing open position, the inviter is prompted by the DBM system whether she wishes to accept remote interviews from anyone for this open position. Such a prompt is in the form of an URL, here denoted URL-1 that is created by the DBM system (501).

URL-1 can look for example like:
http://www.rimsystem.com/DBMID=b80d2160-4287-11de-8a39800200c9a66&InviterID=alan.jones@emailservice1.com&action=createPublicInvitationLink

URL-1 is part of the DBM system and occurs in or connection to an open position being created or edited. The “InviterID” parameter is filled in automatically by the DBM system when a particular inviter logs in (in this case the email address of the inviter Alan Jones is used as ID).

When the inviter is creating a new or editing an existing open position and clicks URL-1, “Accept remote interviews from anyone”, (502), the RIM system is invoked and receives the query parameters including the action parameter “createPublicInvitationLink” which instructs the RIM system to start a process of creating a public invitation link for this open position. The query string parameters DBMID and InviterID are used in authentication/authorization processes (503) of the DBM system itself and the inviter in the same way as described in the first embodiment.

Similar to the first embodiment, the inviter will be prompted to select RIP (504), including the option of selecting a previously saved RIP, parts of previously saved RIPs or creating some or all parameters newly. Selected RIP is specific to an open position but can in this case not be specific to a particular candidate (because the candidate is not known). Therefore, the interview questions and parameters within the RIP could possibly be more generic than in the first embodiment since they may be applicable to a very broad set of potential candidates.

To prevent candidates from inviting themselves to the same remote interview several times, possibly with different login credentials, and thereby learning the questions, the selected interview questions can advantageously be selected among a larger set of interview questions, including the use of randomization or more complex algorithms to select questions. Such aspects, e.g. the randomization scope or pattern among interview questions, may also be part of the parameters selected for the RIP. The selected RIP is stored in the RIM system.

The RIM system then creates a second URL, URL-2, (505) which links to the RIM system and includes as query string parameters the DBMID, a parameter identifying the selected RIP, the InviterID and an action parameter telling the RIP system that a public invitation action is to be performed.
http://www.rimsystem.com/DBMID=b80d2160-4287-11de-8a39800200c9a66&RIPID=23534668ytgh425y56y&InviterID=alan.jones@emailservice1.com&action=publicInvite

URL-2 is then inserted into the open position (506), which can be done manually—the inviters is asked by the RIM system to copy the URL and paste it into the open position web page on DBM's site or on other web pages contain this job opening. It can also be done automatically where URL-2 is passed from the RIM system to the DBM system, and the DBM system will automatically insert URL-2 in the open position. In the latter case to make URL-2 automatically inserted in the open position, the DBM system will create a placeholder on the job post that contains a data field for URL-2. If and when URL-2 is generated, the RIM system will send URL-2 back to the DBM system's data field for this job post through a secure authenticated message exchange that has been setup between the DBM and RIM systems. Whether manually or automatically inserted into the open position, URL-2 is linked to an appropriate text string such as “Interview for this position directly”.

As in the first embodiment, the “Interview for this position directly” button is a URL that directs to the RIM and includes information identifying the selected RIP. However, in contrast to the first embodiment, the candidate can be unknown to the system. Furthermore, even if a prospective candidate may have logged into the DBM system and her credentials exist there, they may still be false. For at least these reasons at least some basic form of authentication of the candidate is advantageously performed before the interview can start.

When a candidate clicks on the “Interview for this position directly” button (507), the RIM system receives the query parameters through URL-2 (described above) and is invoked with the action parameter “publicInvite”. This will invoke that RIM system to prompt the candidate to enter her credentials, including an email address, and preferably also the full name (508). Once these have been properly obtained they are stored by the RIM system.

A third URL, URL-3, is created (509) that links to the RIM system, and which advantageously includes as its query string parameters a unique or quasi-unique Interview Instance Identifier (IIID), which, similarly to the first embodiment, is generated based on:
A code identifying the selected RIP
A code identifying the DBM system provider
Credentials of the inviter, e.g. name and/or email address
Credentials of the candidate, at least the email address

Assuming that the RIM system has the address www.rimsystem.com, URL-3 can look for example like:
http://www.vimsystem.com/IIID=xenij56209-459877650388n887trg-54-gt7-r458767&Action=interview

The action parameter “interview” tells the RIM system that an interview should be performed and the IIID parameter allows the RIM system to retrieve the correct RIP and other parameters and to start the remote interview using the correct parameters.

As in the first embodiment, as an implementation option, an IIID does not necessarily have to be created, but instead the components upon which it is based could be separately included as query string parameters in URL-3.

An electronic message is automatically created and automatically sent by the RIM system to the candidate's entered email address (510). The electronic message can look as in the example below:
To: <candidate's email address>
Dear <candidate's name>,
You are invited to a remote interview for the position of <open position> at <employer>. You may do the interview at any time that suits you, but we kindly ask you to complete it before <completion date>.
To perform the remote interview, please click on the following link:
URL-3
Yours Sincerely,
<inviter>

The information used in the electronic message is retrieved from URL-2, the selected RIP and from the received information from the candidate.

When the candidate clicks on URL-3 in the received electronic message, she will be directed to a web-page where the RIM system will, based on the action parameter “interview” retrieve the correct RIP parameters from the IIID and will guide the candidate through the process of recording the remote interview.

As in the first embodiment, the RIM system can optionally automatically notify the inviter by an electronic message when a remote interview has been recorded.

In order to allow for some control the volume of prospective candidates in this second embodiment of the present invention, means can be provided in the system that allows for certain preconditions to be fulfilled before the actual remote interview is allowed to start. For example, a CV has to be provided by the candidate. Other examples besides a CV can be personal identification or educational diploma that has been certified by the DBM system. The system can also include various automatic semi-automatic, or manual checking processes of the provided documentation that need to be passed before the remote interview can commence. Yet another variation of such control can be that the candidate will be prompted to answer an online questionnaire first, and the system will automatically score/qualify the candidate, so that only if the candidate answers well can she continue to the next step to conduct the remote interview. There may optionally also be measures to prevent unwanted computer programs such as software viruses and similar to access the interview invitation, such as ask the user to fill in displayed letters written in a way that a computer program cannot read them.

As described in the first embodiment, the URLs used in this second embodiment may also include other query string parameters such as e.g. “LanguageID” to adapt to the language of the user.

Although the present invention has been particularly described with reference to the preferred embodiments thereof, is should be readily apparent to those of ordinary skill in the art that changes and modifications in the form of details may be made without departing from the spirit and scope of the invention. For example, while the embodiments have been described largely using the concept of asynchronous remote interview invitations, the invention is not necessarily limited to such and may be applicable also to synchronous remote interview invitations. It is intended that the appended claims encompass such changes and modifications.

What is claimed is:

1. A method for effecting a remote interview invitation, including:
(a) providing a first URL in association with a profile of a candidate at a first web-server, said first URL leading to a second web-server and including at least an email address of said candidate, a parameter identifying an inviter, a parameter identifying said first web-server and a first action parameter instructing said second web-server to start a process to invite said candidate to a remote interview;
(b) upon receipt of said first action parameter at said second web-server:
(i) authenticating and authorizing access to said second web-server;
(ii) selecting and storing one or more remote interview parameters;
(iii) creating a second URL leading to said second web-server and including at least a second action parameter instructing said second web-server to start a process to perform a remote interview, and
(iv) creating and sending an electronic message to said email address of said candidate, said electronic message including said second URL.

2. The method of claim 1 wherein step (b) (ii) further includes the option of selecting new or previously stored one or more remote interview parameters.

3. The method of claim 1, wherein step (b) (i) in claim 1 further includes authenticating and authorizing access based on one or more of: said parameter identifying an inviter and said parameter identifying said first web-server.

4. The method of claim 1, wherein said second URL further includes said one or more remote interview parameters, said email address of said candidate, said parameter identifying an inviter and said parameter identifying said first web-server.

5. The method of claim 1, wherein said second URL further includes a parameter that uniquely or quasi-uniquely identifies said one or more of: said one or more remote interview parameters, said e-mail address of said candidate, said parameter identifying an inviter and said parameter identifying said first web-server.

6. The method of claims 1, wherein said one or more remote interview parameters include one or more of: remote interview questions, information about an open position, the latest date to perform the interview, time allowed to think before answering remote interview questions, time allowed for answering remote interview questions, scores that can he achieved for remote interview questions, language of the remote interview, remote interview question display sequence or algorithm, remote interview question randomize method and a pre-interview questionnaire.

7. A method for generating a remote interview invitation in a first web-server including
(a) receiving a message through a first URL that includes at least a name of a candidate, an email address of a candidate, a parameter identifying an inviter, a parameter identifying a second web-server and a first action parameter instructing said first web-server to start a process to invite said candidate to a remote interview;
(b) authenticating and authorizing access to said first web-server;
(c) selecting one or more remote interview parameters and storing said one or more remote interview parameters in memory storage;
(d) generating a second URL directed to said first web-server and including at least a second action parameter instructing said first web-server to start a process to perform and record a remote interview, and
(e) generating an electronic message including said second URL and sending said electronic message to said email address of said candidate.

8. The method of claim 7 wherein step (c) further includes the option of selecting new or previously stored one or more remote interview parameters.

9. The method of claim 7, wherein step (b) in claim 7 further includes authenticating and authorizing access based on one or more of: said parameter identifying an inviter and said parameter identifying said second web-server.

10. The method of claim 7, wherein said second URL further includes said one or more remote interview parameters, said email address of said candidate, said parameter identifying an inviter and said parameter identifying said second web-server.

11. The method of claim 7, wherein said second URL further includes a parameter that uniquely or quasi-uniquely identifies said one or more of: said one or more remote interview parameters, said e-mail address of said candidate, said parameter identifying an inviter and said parameter identifying said second web-server.

12. The method of claim 7, wherein said one or more remote interview parameters include one or more of: remote interview questions, information about an open position, the latest date to perform the interview, time allowed to think before answering remote interview questions, time allowed for answering remote interview questions, scores that can be achieved for remote interview questions, language of the remote interview, remote interview question display sequence or algorithm, remote interview question randomize method and a pre-interview questionnaire.

13. A method for effecting remote interview invitations, including:
(a) providing a first URL at a first web-server, said URL leading to a second web-server and including at least a parameter identifying an inviter, a parameter identifying said first web-server and a first action parameter instructing said second web-server to start a process to create a public invitation link;
(b) upon receipt of said first action parameter at said second web-server:
(i) authenticating and authorizing access to said second web-server;
(ii) selecting and storing one or more remote interview parameters;
(iii) creating a second URL leading to said second web-server and including at least a second action parameter instructing said second web-server to start a public invitation process;
(c) providing said second URL at said first web server;
(d) upon receipt of said second action parameter at said second web server:
(i) obtaining and storing at said second web server the name and email address of a candidate;
(ii) creating a third URL leading to said second web-server and including at least a second action parameter instructing said second web-server to start a process to perform and record a remote interview, and
(iii) creating an electronic message including said third URL and sending said electronic message to said email address of said candidate.

14. The method of claim 13, wherein step (b) (ii) further includes the option of selecting new or previously stored one or more remote interview parameters.

15. The method of claim 13, wherein step (b) (i) in claim 13 further includes authenticating and authorizing access based on one or more of: said parameter identifying an inviter and said parameter identifying said first web-server.

16. The method of claim 13, wherein said second URL further includes said one or more remote interview parameters, said parameter identifying an inviter and said parameter identifying said first web-server.

17. The method of claim 13, wherein said second URL further includes a parameter identifying said one or more remote interview parameters, said parameter identifying an inviter and said parameter identifying said first web-server.

18. The method of claim 13, wherein said third URL further includes said one or more remote interview parameters, said email address of said candidate, said parameter identifying an inviter and said parameter identifying said first web-server.

19. The method of claim 13, wherein said second URL further includes a parameter that uniquely or quasi-uniquely identifies said one or more of: said one or more remote interview parameters, said e-mail address of said candidate, said parameter identifying an inviter and said parameter identifying said first web-server.

20. The method of claim 13, wherein said one or more remote interview parameters include one or more of: remote interview questions, information about an open position, the latest date to perform the interview, time allowed to think before answering remote interview questions, time allowed for answering remote interview questions, scores that can be achieved for remote interview questions, language of the remote interview, remote interview question display sequence or algorithm, remote interview question randomize method and a pre-interview questionnaire.
